(19) United States
(12) Patent Application Publication
(10) Pub. No.: US 2011/0040582 A1
(43) Pub. Date: Feb. 17, 2011

(54) ONLINE SYSTEM AND METHOD OF INSURANCE UNDERWRITING

(76) Inventor: Kieran Mullins, Windsor, CT (US)

Correspondence Address: Troutman Sanders LLP, The Chrysler Building, 405 Lexington Avenue, New York, NY, 10174, US

(21) Appl. No.: 12/542,500

(22) Filed: Aug. 17, 2009

(51) Int. Cl. G06Q 40/00

(52) U.S. Cl. 705/4

(57) ABSTRACT

A user accesses online forms, enters information, and submits the data to an insurance underwriting server. The information may address health, family history, the applicant's profession, or planned physical activities. The applicant also authorizes the server to retrieve stored information about the applicant. The stored information may include DMV records, prescription drug records, credit reports, information from prior insurance applications, or medical records. The server receives the applicant's information and authorization to access the stored information. The server retrieves the stored information, then computes mortality risk based on the applicant's information and the retrieved information. If the mortality risk is deemed to be too high, the server can transition the user and/or applicant to a customer service representative, or the server can decline to underwrite an insurance policy. If the mortality risk is not too high, the server computes a premium rate that corresponds to the mortality risk, and offers to underwrite an insurance policy for the applicant at the specified premium rate.

### TECHNICAL FIELD

The disclosed embodiments relate generally to insurance underwriting. In particular, the disclosed embodiments relate to an online method of underwriting insurance, including life insurance.

### BACKGROUND

The life insurance application process can be very complex and can take a very long time, creating barriers to issuing insurance. For example, underwriting a life insurance policy may take six to eight weeks or longer, require extensive paperwork, and potentially require blood tests, urine tests, or a medical examination.

With greater access to the Internet, users expect a faster and simpler insurance application process. The time and complexity of a typical insurance application process thus create significant barriers to issuing insurance policies.

To expedite the insurance application process, some companies offer an online application process, which may reduce the associated time and complexity. However, without access to key mortality information, policies that are issued quickly must rely on general demographic information, such as age, gender, whether a person uses tobacco, and some other basic health and lifestyle information. Without a more detailed mortality risk assessment, the premiums generally must be higher for all such applicants.

Therefore, life insurance underwriting needs a method that combines the speed of a computerized underwriting process with a more detailed mortality risk assessment so that the insurance provider may offer the premium rate to the consumer in the shortest possible time.

### SUMMARY

The present invention addresses the above deficiencies and other problems associated with prior insurance underwriting methods. Embodiments of the present invention provide a quick online application process and also calculate mortality risk based on information retrieved from multiple internal and external databases. In some embodiments, the online application process targets specific demographic groups, such as the age range 18-40, where there are generally fewer medical issues to address than at older ages. In some embodiments, the application process limits the available face value of the proposed policy. For example, the online application process may limit the face value to $500,000; for greater coverage the applicant would need to transition to a traditional application process. In some embodiments, the online application process may target a specific demographic group and limit the face value of the proposed policy. By limiting the target population and/or the target face value of the insurance policy, the application process is made simpler and thus more suitable to an online process. In some embodiments, the target demographic or target face value may be larger or smaller depending on what electronic information is available.

In an online insurance application process, a user interacts with a computer to enter information, typically with a keyboard and a mouse or other pointing device. The application process seeks insurance coverage for an applicant. In some instances, the user is the same person as the applicant, and the user enters data about himself/herself. In other instances, the user may be an agent or other person entering data on behalf of the applicant. The remainder of this specification will use the terms “user” and “applicant” to identify the roles as indicated above, even though the two terms may refer to the same person.

In addition, a potential insurance policy owner may be the same person as the potential insured, or may be a different person from the potential insured. To avoid the linguistic complexity of distinguishing the two people in this scenario, the term “applicant” as used herein will encompass the potential insured or the potential insurance policy owner or both, and one skilled in the art will recognized in any given context/situation whether one or the other or both may be involved.

In some embodiments of the present invention, an online insurance application process accesses a database maintained by the Medical Information Bureau (MIB) that includes coded medical and non-medical information on prior insurance applications or existing insurance policies. References to the MIB database as used herein apply to any database that maintains similar information. In some embodiments of the present invention, an online insurance application process accesses driving records from Departments of Motor Vehicles (DMV) or other Motor Vehicle Record (MVR) databases. References herein to DMV records or MVR records are interchangeable, and apply to any database that maintains similar motor vehicle driving records. In some embodiments of the present invention, an online insurance application process accesses information from a credit reporting agency or other information source to verify an applicant's identity. References herein to a “verification process” apply to any credit reporting agency or other company that maintains a database capable of verifying an applicant's identity. In some embodiments of the present invention, an online insurance application process accesses a prescription database that provides current and/or historical information about prescriptions a person has filled. References herein to “a prescription database,” “the prescription database,” “an Rx database,” or “the Rx database” apply to any database that can provide current and/or historical information about what prescriptions a person has filled. In some embodiments of the present invention, an online insurance application process accesses one or more credit reports from credit reporting agencies. In some embodiments, credit information is retrieved from non-FCRA sources, such as publicly available records. (FCRA refers to the Fair Credit Reporting Act, as amended.) In some embodiments, credit reports are retrieved from FCRA sources to the extent allowed by Federal law. References herein to credit reports include any reports containing an applicant's credit or financial information that may be legally retrieved and used in an insurance application process.

Once a user begins the online application process, there are several possible outcomes. First, the user may abandon the process prematurely. If the user does not quit prematurely, all of the data is aggregated to produce one of three outcomes: the applicant may be transitioned to a traditional underwriting process; the applicant is provided with an offer for coverage; or the applicant may be denied coverage. The application process may access data from multiple sources, and the data from each source may yield an independent basis for assessing mortality risk. The data from each of these sources is a factor that combines with the other sources to calculate a final risk classification.

In one exemplary method for underwriting an insurance policy, a user accesses online forms provided by an underwriting server. The user enters information on the online forms, and submits them to the underwriting server. The information may include health information, family history, information about the applicant's profession, information about planned physical activities (such as flying non-commercial aircraft, parachuting, hang gliding, mountain climbing, contact sports, or other activities that increase the risk of injury or death), information about the applicant's build (e.g., height and weight), information about tobacco use, as well as general demographic data. The applicant also provides authorization for the underwriting server to retrieve confidential information about the applicant. The confidential information may include any of the following: DMV records, prescription drug records, one or more credit reports, information from prior insurance applications concerning the applicant (e.g., from the Medical Information Bureau), and medical records. The confidential information includes a plurality of characteristics pertaining to the health, profession, or planned physical activities of the applicant. The underwriting server receives the information supplied by the user as well as the applicant's authorization to access the confidential information. The underwriting server retrieves the confidential information, then computes the risk that the applicant has supplied inconsistent or fraudulent information by comparing the information supplied by the applicant to the information retrieved from one or more databases. If there is inconsistent information or evidence to suggest fraud, the application process will transition to a conversation between the user and/or applicant and a customer service representative. Such a conversation may be over a telephone, live chat, or other form of live communication. In some embodiments, a customer service representative may evaluate the information provided by the user to determine whether the application process should proceed online, transition to traditional underwriting, or terminate with a declination of coverage.

In another exemplary method for underwriting an insurance policy, a user accesses online forms provided by an underwriting server. The user enters information on the online forms, and submits them to the underwriting server. The information about the applicant may include health information, family history, information about the applicant's profession, information about planned physical activities (such as flying non-commercial aircraft, parachuting, hang gliding, mountain climbing, contact sports, or other activities that increase the risk of injury or death), information about the applicant's build, information about tobacco use, as well as general demographic data. The applicant also provides authorization for the underwriting server to retrieve confidential information about the applicant. The confidential information may include one or more of the following: DMV records, prescription drug records, one or more credit reports, information from prior insurance applications concerning the applicant (e.g., from the Medical Information Bureau), and medical records. The underwriting server receives the information supplied by the user as well as the applicant's authorization to access the confidential information. The underwriting server retrieves the confidential information, then computes the mortality risk (or risk class) of the applicant based on the information submitted by the user as well as the retrieved confidential information. When the mortality risk exceeds a certain threshold value, the application process transitions to a traditional underwriting process. In some embodiments, when the mortality risk exceeds a designated value, the online application process initiates a live conversation (such as by telephone or live chat) between the user and/or applicant and a customer service representative. Following a conversation with a customer service representative, the user and/or applicant may be returned to the online application process, or the application may be transitioned to a traditional underwriting process. In some embodiments, if the risk class is less than standard, the application is transitioned to a “traditional” underwriting process. In some embodiments, if the mortality risk is below the threshold value, the underwriting server computes a premium rate that corresponds to the mortality risk, and offers to issue an insurance policy for the applicant at the specified premium rate. The offer is sent to the applicant. In other embodiments, if the mortality risk exceeds a certain threshold value, the underwriting server declines to underwrite an insurance policy for the applicant, and sends the declination to the applicant.

In another exemplary embodiment, a method is provided for calculating mortality risk of an applicant based on information contained in one or more credit reports for that applicant. A server receives a request to calculate mortality risk for a specific applicant, and receives authorization to retrieve one or more credit reports for that applicant. In general, the credit reports are provided by national credit reporting agencies, such as Equifax, TransUnion, and Experian, but the method applies to any credit report that provides financial information about the specified applicant. The server associates some items of information on the credit reports with increased or decreased mortality risk, and thereby computes a mortality risk. The computation is based on the underlying data, and not a credit score (e.g., FICO) provided by credit reporting agencies. In some embodiments, credit report data is used to verify the identity of an applicant, which may be used for an electronic signature (e-Signature).

The disclosed embodiments thus provide methods of quickly applying for insurance online, and providing an appropriate premium rate based on a more accurate assessment of an applicant's mortality risk than the current online application and underwriting processes that exist in the marketplace. In some cases the online application process leads to full insurance underwriting for the applicant within 15 to 20 minutes.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 illustrates the environment in which electronic insurance underwriting occurs in accordance with some embodiments.

FIG. 2 is a schematic diagram of a client system utilizing electronic underwriting in accordance with some embodiments.

FIG. 3 schematically illustrates a server that performs an electronic underwriting process in accordance with some embodiments.

FIG. 4 provides a conceptual outline of an online underwriting system in accordance with some embodiments.

FIGS. 5 and 6 illustrate the operations of an online underwriting process in accordance with some embodiments.

FIG. 7 illustrates database processes that are utilized to performing an online underwriting process in accordance with some embodiments.

FIG. 8 illustrates a process for detecting potential fraud using information from the Medical Information Bureau (MIB) in accordance with some embodiments.

FIG. 9 illustrates a process for determining mortality risk using information from a prescription drug database in accordance with some embodiments.

FIGS. 10-12 illustrate a process for determining mortality risk using DMV (Department of Motor Vehicles) records in accordance with some embodiments.

FIG. 13 illustrates a process for determining premium rates based on the build (e.g., height and weight) of the applicant in accordance with some embodiments.

FIG. 14 illustrates a process for determining mortality risk using information from a credit report in accordance with some embodiments.

FIG. 15 illustrates a process used when the proposed insurance will replace existing insurance in accordance with some embodiments.

FIG. 16 illustrates a process for determining mortality risk and determining a premium rate based on the family history of the applicant in accordance with some embodiments.

FIG. 17 illustrates a process for determining mortality risk and determining a premium rate based on the avocation and aviation history or plans of the applicant in accordance with some embodiments.

FIG. 18 illustrates a process for determining mortality risk and determining a premium rate based on the hospitalization history of the applicant in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known components and elements have not been described in detail so as not to unnecessarily obscure aspects of the embodiments.

It will also be understood that, although the terms first, second, etc., or primary, secondary, etc. may be used herein to describe various elements of the embodiments, these elements should not be limited by these terms. These terms are only used to distinguish one element from another.

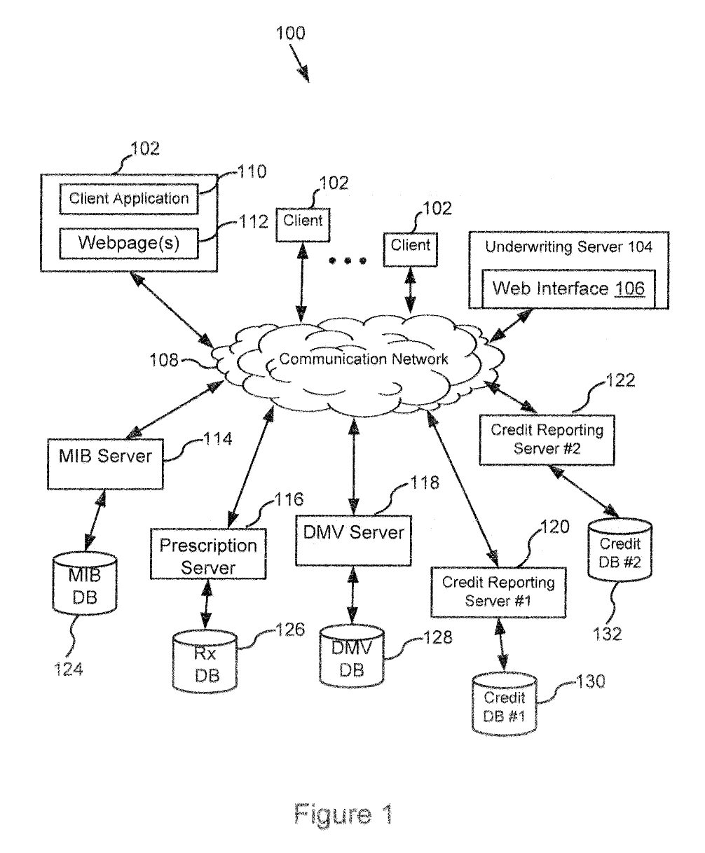

An exemplary environment 100 for embodiments of the present invention is illustrated in FIG. 1. One or more client computers 102 communicate with an underwriting server 104 over a communication network 108. The communication network 108 may be the Internet, a Local Area Network (LAN), a Wide Area Network (WAN), or any other communication network 108 that allows client computers 102 to communicate electronically with an underwriting server 104. The underwriting server 104 includes a web interface 106 that connects to communication network 108. At a client computer 102 there may be one or more client software applications 110, such as a web browser. For example, the browser may be an Internet Explore®, Firefox®, or Safari® browser. A browser may load web pages 112 provided by the underwriting server 104 as part of the online insurance application process.

The underwriting server 104 retrieves data from a plurality of sources over a communication network 108. Note that the communication between the underwriting server and the data sources need not be over the same communication network as the communication between client computers 102 and the underwriting server 104. For example, client computers 102 may communicate with the underwriting server over the Internet, whereas the underwriting server 104 may communicate with one or more of the data sources over a LAN.

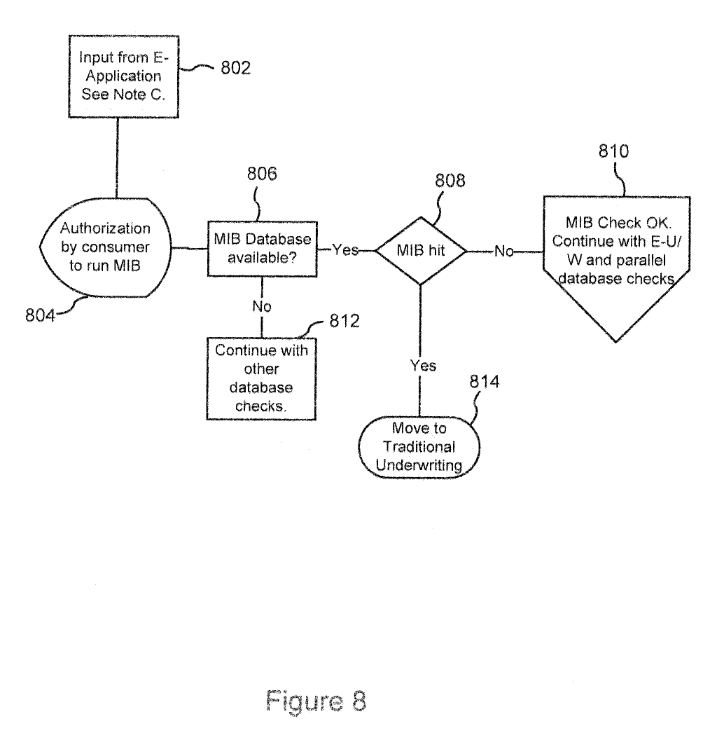

One exemplary data source is the Medical Information Bureau 114, which maintains its own database 124. The MIB database 124 includes data from prior insurance applications. The process of using the MIB data is described more fully below with respect to FIG. 8. One of skill in the art would recognize that alternative sources of the same data may be available.

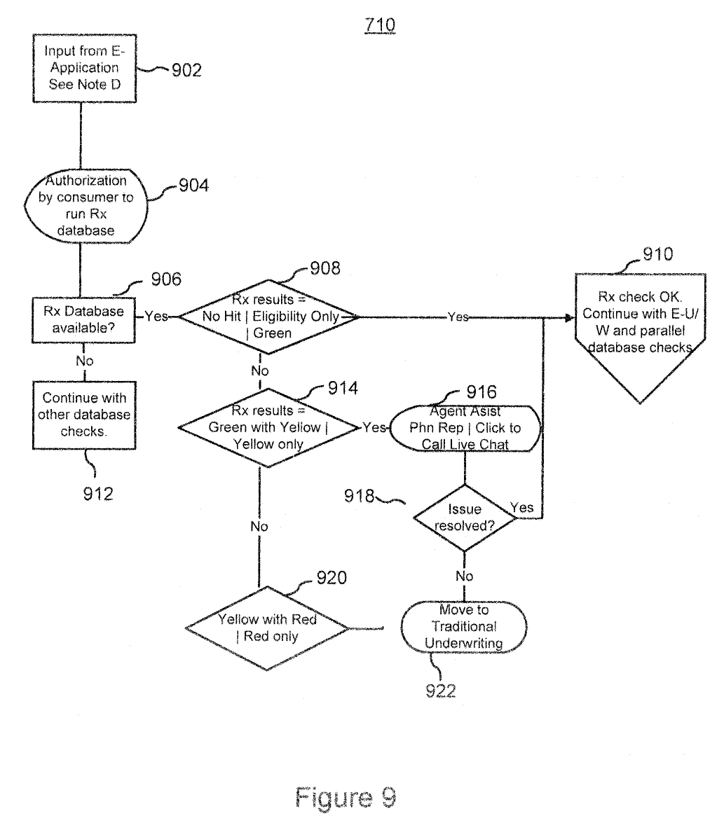

Another exemplary data source provides prescription drug data. Prescription server 116 receives requests from underwriting server 104, including enough information to identify an individual person, and the prescription server returns records from the prescription database 126 that match the identified individual person. In some embodiments, an individual person is identified by social security number. In other embodiments, an individual person is identified by a plurality of characteristics, such as name and address. The process of using the prescription server is explained more fully below with respect to FIG. 9.

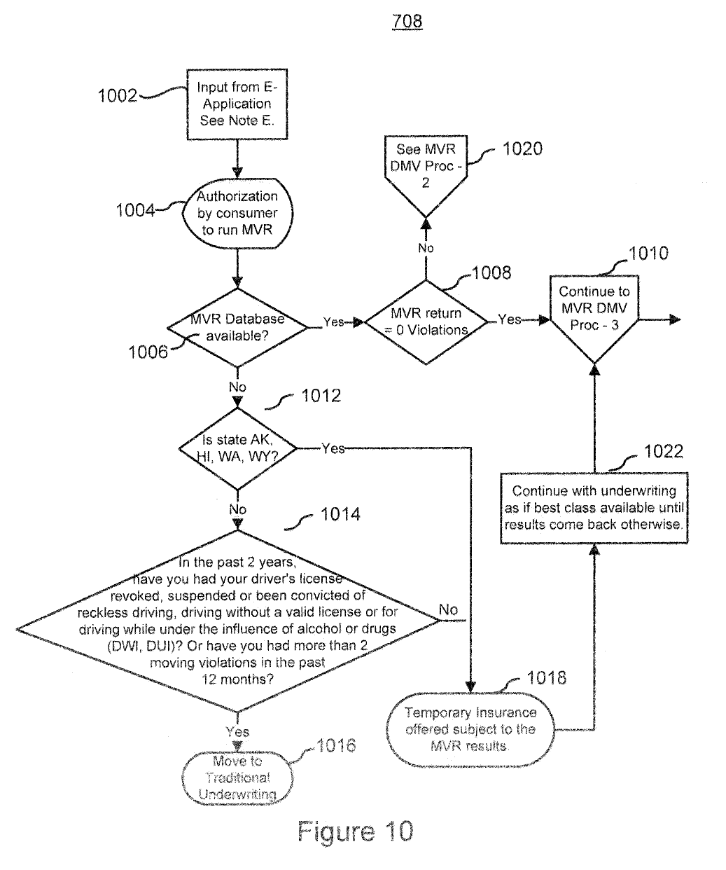

Other exemplary data sources are departments of motor vehicles, which may provide access to their data through a DMV server 118. As noted earlier, Motor Vehicle Records (MVR) may be available from sources other than departments of motor vehicles, so statements herein regarding DMV records apply to any MVR source. DMV data is stored in one or more DMV databases 128. The underwriting server 104 requests information from a DMV server 118, and provides sufficient information to identify an individual person. In some embodiments, an individual person is identified by state and driver's license number. One of skill in the art would recognize that a state could provide multiple DMV servers, or multiple states could consolidate their data into a single database with a single DMV server. Alternatively, a single DMV server 118 could access data from two or more distinct DMV databases 128. The process of using DMV data to determine mortality risk is described more fully below with respect to FIGS. 10-12.

The underwriting server 104 may also retrieve credit reports from one or more credit reporting services 120 and 122. Although FIG. 1 displays two credit reporting servers 120 and 122, some embodiments may use only one credit reporting server. Alternatively, some embodiments may use three or more credit reporting services. As is well known, the primary credit reporting services in the United States are Equifax®, TransUnion®, and Experian®. In some embodiments, credit report information is retrieved from LexisNexis®, ChoicePoint®, or Accurint®. In some embodiments, the underwriting server may use only one credit reporting service, but may select which service to use depending on which service is currently available. Each credit reporting service maintains a database of credit data, as illustrated by credit databases 130 and 132 in FIG. 1. As noted earlier, some embodiments use credit report data to verify an applicant's identity instead of, or in addition to, using the credit report data to estimate mortality risk.

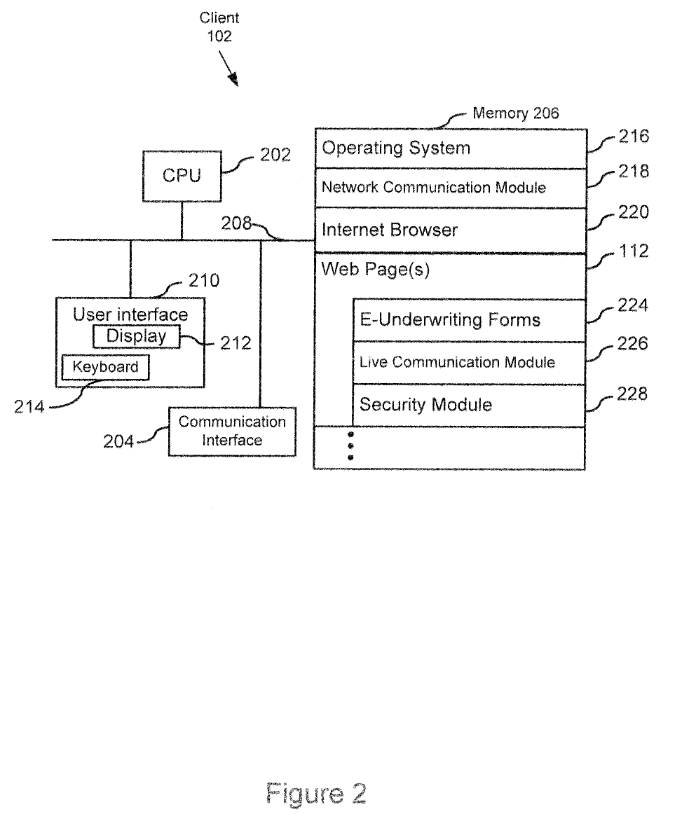

FIG. 2 illustrates an exemplary client computer 102. The client computer 102 has a processor 202 and a communication interface 204, which allows the client computer 102 to communicate over the communication network 108 (shown in FIG. 1). The client computer also has a user interface 210, which includes a display 212. The client computer may have a keyboard 214. The client computer may also have a mouse or other pointing device, such as a touchpad, to control a cursor position on the display. The client bus 208 provides internal communication between the processor 202, the user interface 210, the communication interface 204, and the memory 206.

Memory 206 in FIG. 2 may include high-speed random access memory and may also include non-volatile memory, such as one or more magnetic disk storage devices, flash memory devices, or other non-volatile solid-state memory devices. Memory 206 includes one or more computer readable storage mediums. Stored in the memory 206 are an operating system 216, a network communication module 218, and Internet browser 220. As the browser 220 accesses the e-Underwriting forms 224, the forms 224 are stored in the memory 206. The forms 224 are included in the web pages 112 that are displayed in the browser. In some embodiments, a security module 228 operates to protect the information entered by the user. For example, the security module may use a secure socket layer (SSL) to transmit the data (e.g., HTTPS). In some embodiments, a live communication module 226 is stored in memory 206, enabling a user to communicate with a person. Exemplary live communication methods include voice and live chat.

In some embodiments, the client computer 102 belongs to a sales representative or other person who accesses the online application process on behalf of an applicant. For example, a sales representative may enter data into an online insurance application on a client computer 102 while speaking to an applicant over a telephone. In some embodiments, the online insurance application process provides additional or advanced features when accessed directly by a representative of the company providing insurance. For example, a representative may be able to override default behavior of the online application process. Although FIG. 2 shows a “computer system,” FIG. 2 is intended more as functional description of the various features which may be present in a computer system than as a structural schematic of the embodiments described herein. In practice, and as recognized by those of ordinary skill in the art, items shown separately could be combined and some items could be separated. For example, some items shown separately in FIG. 2 could be implemented on a single computer system and single items could be implemented by one or more computer systems.

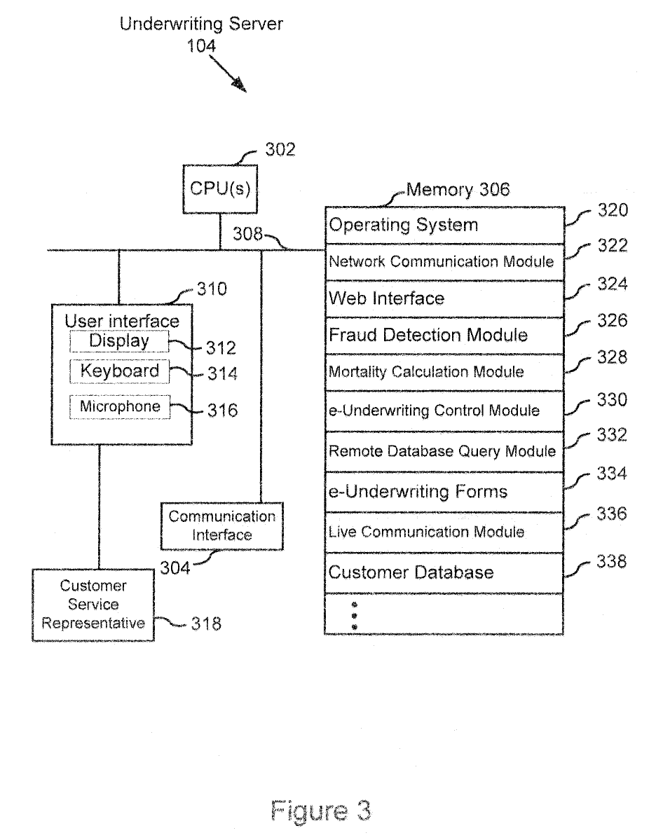

FIG. 3 illustrates an exemplary underwriting server 104. An underwriting server 104 includes one or more processors 302, one or more communication interfaces 304, and memory 306. In some embodiments, the underwriting server has a user interface 310, allowing for interacting with a human user. When the underwriting server 104 has a user interface 310, it would typically include a display 312 and keyboard 314. In some embodiments, the user interface would also include a microphone 316, allowing for voice communication by a customer service representative 318. The server bus 308 provides for internal communication between the processors 302, the communication interface 304, the memory 306, and the user interface 310.

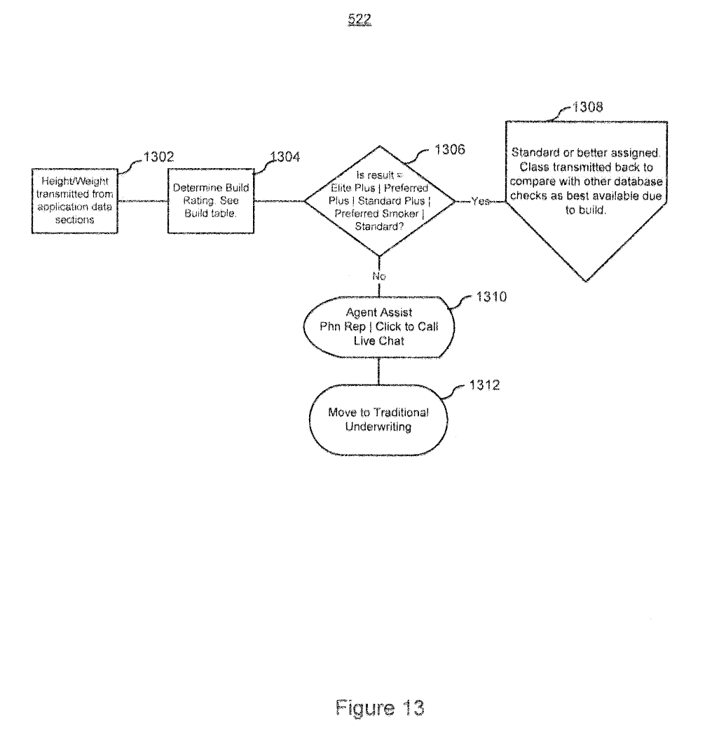

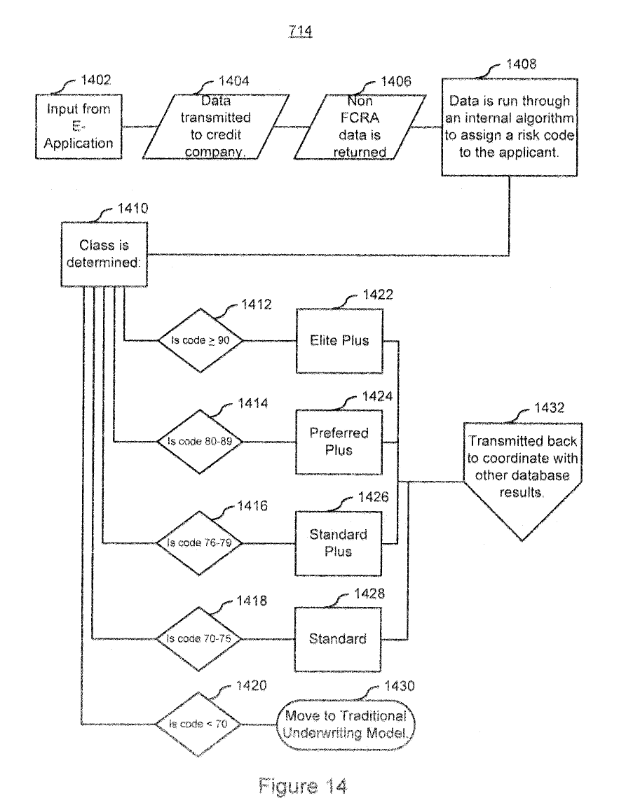

Memory 306 in FIG. 3 may include high-speed random access memory and may also include non-volatile memory, such as one or more magnetic disk storage devices, flash memory devices, or other non-volatile solid-state memory devices. Memory 306 includes one or more computer readable storage mediums. Stored in the memory 306 are an operating system 320, a network communication module 322, and web interface program 324. In some embodiments, memory 306 stores a fraud detection module 326, described more fully below with respect to FIG. 8. Memory 306 also stores a mortality calculation module 328. In some embodiments, the mortality calculation module 328 calculates mortality risk based on prescription drug data, which is described more fully below with respect to FIG. 9. In some embodiments, the mortality calculation module 328 calculates mortality risk based on records from one or more departments of motor vehicles. This is described more fully below with respect to FIGS. 10-12. In some embodiments, mortality calculation module 328 calculates mortality risk based on credit report data. This is described more fully below with respect to FIG. 14. In some embodiments, the mortality calculation module 328 calculates mortality risk based on data entered by the user, such as family history, avocation, aviation, hospitalization history, or the physical build of the person. These calculations are described more fully below with respect to FIG. 13 and FIGS. 16-18. In some embodiments, the mortality calculation module 328 calculates mortality risks based on multiple independent factors, then aggregates the results to compute a single overall mortality risk. In some embodiments, the aggregation of independent mortality risks uses the highest risk (i.e., lowest rating class) from the individual calculations. In other embodiments, the aggregation of independent mortality risks is based on the average or weighted average of the individual mortality calculations. In some embodiments, the aggregation of independent mortality calculations may result in a transition to traditional underwriting, where human underwriters can make the final determination. In some embodiments, the aggregate mortality calculation may be sufficiently high that no coverage is offered.

In some embodiments, memory 306 stores an e-Underwriting control module 330, which controls the entire process. Memory 306 also stores remote database query module 332, which retrieves data from remote databases. An exemplary set of remote databases is shown in FIG. 1 and described above. The memory 306 on the underwriting server 104 also stores the electronic forms 334 that are transmitted to the client computer for data entry. A live communication module 336 in memory 306 enables live communication between the user and/or applicant and a customer service representative 318 using voice, live chat, or other real-time methods of communication. A customer service representative may be any individual who communicates with users and/or applicants on behalf of the company providing the underwriting services. For example, a customer service representative may be a licensed representative who is not necessarily employed by the company providing the proposed insurance. A customer database 338 stored in memory 306 stores data entered by the user, retrieved from an external source, or calculated based on other data. In some embodiments, memory 306 also stores one or more ancillary modules, which provide services related to an insurance application.

One of skill in the art would recognize that the functions described above for underwriting server 104 may be performed by a plurality of servers, and need not be executed on a single physical server.

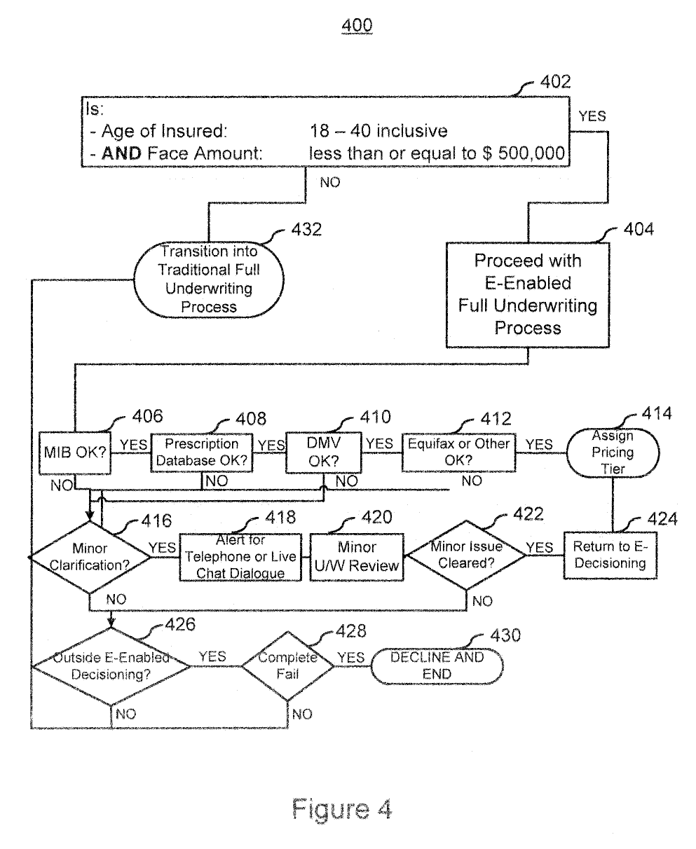

FIG. 4 illustrates an exemplary outline of an online life insurance application process 400. Depending on the information reviewed, there are three possible outcomes: (1) the application is referred to a “traditional” (not online) underwriting process; (2) the application results in an offer for insurance at an appropriate premium rate; or (3) the application is declined. In the illustrated embodiment, an initial determination 402 is made based on the age of the applicant and the desired face amount for the life insurance policy. If the applicant is not in the range of 18 to 40 years old, the traditional underwriting process is required (432). In addition, if the applicant wants more than $500,000 of insurance, the traditional underwriting process is required (432). If the applicant is between 18 and 40 and seeks at most $500,000 of insurance, then the process proceeds with the electronic underwriting process (404). In other embodiments, an initial determination 402 may use a different age range, a different face value limit, or other screening criteria. In some embodiments, there is no initial determination 402. When there is an initial determination, after an initial determination 402, one or more database operations 406-412 are performed, as described more fully below. The database operations 406-412 retrieve data using the Remote Database Query Module 332 stored in memory 306 on Underwriting Server 104.

In some embodiments, the method of online underwriting screens for potential fraud. In some cases an applicant may apply for insurance through one carrier, then apply through a second carrier after being denied by the first. In the second insurance application, the applicant may alter some of the responses in order to procure insurance, or procure insurance at a better rate. One way to detect this potential fraud is to compare (406) data currently entered about an applicant with data gathered about the applicant. The data gathered may include information previously entered by the applicant, or other publicly available information. The data to be gathered may be available in the Medical Information Bureau (MIB) database. The fraud detection operation (406) is described more fully below with respect to FIG. 8. In some embodiments, the MIB database also provides coded medical or non-medical information, or may identify prior applications for insurance with the same or other insurance carriers. In some embodiments, data may be available from the insurance company's internal databases regarding in-force coverage, past declines, or rated cases. A “rated case” is an instance where the applicant has been offered coverage at a substandard rate. In some embodiments, any information retrieved from the MIB database or a similar database must be verified from another source. In some embodiments, an online insurance application process uses this additional data to determine whether to offer coverage or to establish an appropriate premium rate. The detection of potential fraud is performed by the Fraud Detection Module 326 stored in memory 306 on Underwriting Server 104.

In some embodiments, the method assesses (408) mortality risk based on a prescription drug database. The prescription drug database provides a listing of the prescription drugs that the applicant has filled, which may provide information about mortality risk. Certain classes of drugs, such as antibiotics may not correlate to mortality; as such, they would not affect the mortality estimate. However, drugs prescribed for a variety of ailments including mental illness may indicate substantially increased mortality risk. As described more fully below with respect to FIG. 9, drugs are grouped into classes based on their potential indication of the level of mortality risk. The classification of drugs may be provided by the remote prescription drug database, or may be determined by other reference information such as the Physicians Desk Reference (PDR). In some embodiments, an insurance carrier may develop drug classifications based on medical training, published medical research, published clinical trials, or other sources of information about prescription drugs. The calculation of mortality risk based on prescription drugs may be performed by a Mortality Calculation Module 328 stored in memory 306 on Underwriting Server 104.

In some embodiments, the method assesses (410) records from departments of motor vehicles. Automobile accidents are a leading cause of death among people in the target age range (18-40), so driving history is a factor in mortality risk. The use of DMV records to assess mortality risk is described more fully below with respect to FIG. 10-12. The calculation of mortality risk based on motor vehicle records may be performed by a Mortality Calculation Module 328 stored in memory 306 on Underwriting Server 104.

In some embodiments, the method retrieves one or more credit reports and computes mortality risk from information on the credit report. In these embodiments, the estimated mortality risk is compared (412) to a threshold value to determine whether to offer the applicant an insurance policy. The usage of credit reporting data to assess mortality risk is described more fully with respect to FIG. 14 below. The calculation of mortality risk based on credit reports or other financial data may be performed by a Mortality Calculation Module 328 stored in memory 306 on Underwriting Server 104.

The online underwriting method applies one or more of the tests 406-412. If the application process passes each of the applied tests, the method proceeds to assigning (414) a pricing tier and a premium rate corresponding to the pricing tier. There can be multiple pricing tiers and each pricing tier can have a corresponding premium rate. On the other hand, if the application process fails one or more of the applied tests, the method determines (416) whether a minor clarification might resolve the issue. If so, the method initiates (418) a telephone conversation or live chat to potentially resolve the issue. The method then reviews (420) the additional information received from the user, and determines (422) whether the additional information resolved the issue. In some embodiments, the online application process continues (424) when the issue is resolved, which may proceed immediately to assigning 414 a pricing tier, or may return to complete other tests 406-412 that have not yet been performed. In some embodiments, the online application process may transition to traditional underwriting when the issue is resolved.

If the applied tests result in an issue that is not minor, or an issue that cannot be resolved, the application process cannot be completed online (426). In this case, the severity of the issue determines (428) whether to decline (430) or to transition (432) to a traditional underwriting process.

Note that the operations described with reference to FIG. 4 are for an exemplary embodiment of an online life insurance application process. Different embodiments can employ different combinations and ordering of the operations, including the tests 406-412, and subsets or supersets of the operations, consistent with achieving one or more goals of the present invention. These goals include providing a speedy (e.g., on the order of tens of minutes) life insurance underwriting process for defined groups of applicants (such as those in the age group 18-40 inclusive) and policy face amounts (such as less than or equal to $500,000) through the analysis of specific user-provided information and information from one or more online databases. For certain defined groups of applicants and policy face amounts, the online application process has a reliability that is comparable to that of the traditional full underwriting process.

In some embodiments, the operations, including the tests 406-412, are ordered so as to provide a desirable online user experience during the application process. In some embodiments, a desirable online user experience is associated with minimal user-perceived response delay and overall process duration. In some embodiments, these factors can be attributed to the relative responsiveness of the computer modules 320-338 (including their associated database accesses), which collectively implement the online insurance underwriting process, further described for some embodiments with reference to FIGS. 4-18. In some embodiments, the user-perceived delay and overall process duration are minimized by positioning operations that are relatively slower in returning a response (and the associated questions used to obtain related information about the user) earlier in the underwriting process flow rather than later. For example, given that responses from the prescription database 126 (FIG. 1) are known to be slow, the prescription database check (408) could be staged in the overall process 400 such that the information about the applicant needed to access that database 126 is obtained, and the database 126 query issued, earlier in the underwriting process.

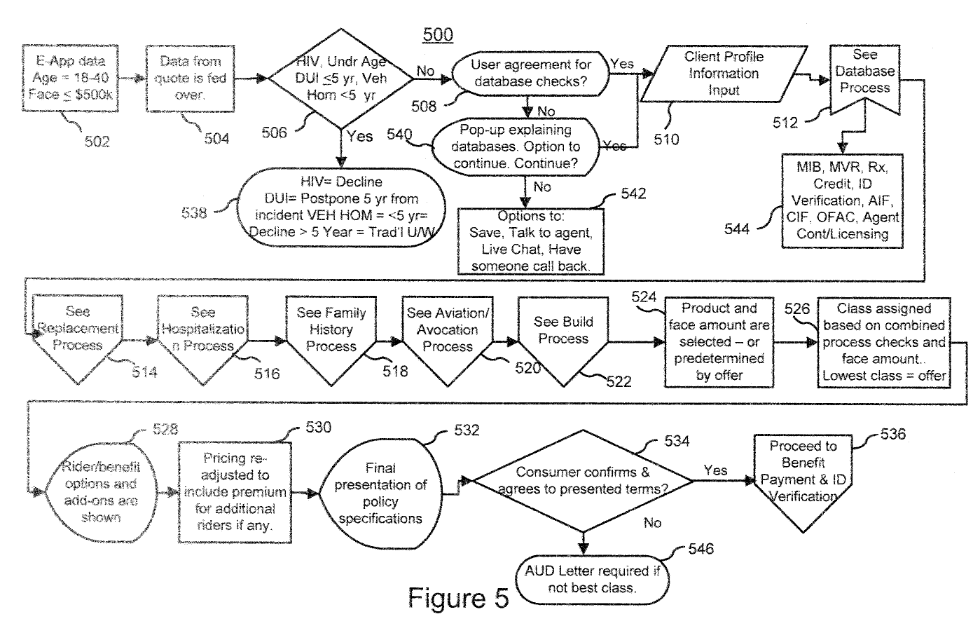

FIG. 5 illustrates an exemplary process flow 500 for online underwriting of an insurance policy. The overall process flow 500 is controlled by e-Underwriting Control Module 330, which is stored in memory 306 on Underwriting Server 104. In the embodiment of FIG. 4, the online process requires that the applicant age be in the range of 18-40 and that the face amount of the desired life insurance be less than or equal to $500,000. In other embodiments, the age range may be different, the face amount limit may be different, or alternative criteria may be used instead of, or in addition to, these criteria. In the embodiment of FIG. 5, the process flow begins by making the same two assumptions about age and face value (502). In some embodiments, there is an initial quote for the applicant based on limited information. The initial data input by the user is fed into the subsequent process when the applicant decides to continue with the application process (504). The data fed over may include the applicant's full name, date of birth, gender, driver's license number and state of issuance, social security number, height and weight, full address, including zip code, and whether or not the applicant is a smoker.

In some embodiments, the applicant answers some preliminary question or questions that may prevent the applicant from obtaining insurance (506) or may require an applicant and/or user to clarify the applicant's answers with a customer service representative. Preliminary questions may include, for example, whether the person has HIV, whether the applicant was convicted of under age DUI, has been convicted of multiple DUI's within the past five years, or whether the applicant is currently on parole for a recent conviction for vehicular homicide (506). In some embodiments, the application is transitioned to a traditional underwriting process (432) that involves having the user and/or applicant speak to a customer service representative if the applicant has HIV, has been convicted of vehicular homicide in the past five years (538), has been convicted of under age DUI in the past five years, or has been convicted of multiple DUI's within the past five years. The preliminary questions may include additional questions, fewer questions, or may be alternative similar questions to the exemplary ones identified above. In particular, the questions can be adapted to address new or updated mortality statistics. In some embodiments, these answers can result in the automatic denial of the insurance application.

If the applicant answers “no” to all of the preliminary questions, the applicant must then authorize retrieval of private personal information from external databases (508). This authorization request is early in the application process because the retrieval of data from external third party databases may take-considerable time. The data retrieval can occur asynchronously while the user continues with the application process. If the applicant does not agree to authorize the database checks, the online process provides additional information to the user about why retrieval of information from the databases is needed (540). If the applicant still refuses to give authorization, the user and/or applicant has the option to speak to a customer service representative, have a representative call back, or have a live chat with a customer service representative (542). In general, the online application process cannot continue without this authorization.

After receiving database access authorization, the online application process initiates retrieval of the needed information from the databases, and prompts the user to enter profile information about the applicant (510). Profile information may include basic information about an applicant, including name, address, Social Security Number, date of birth, and so on.

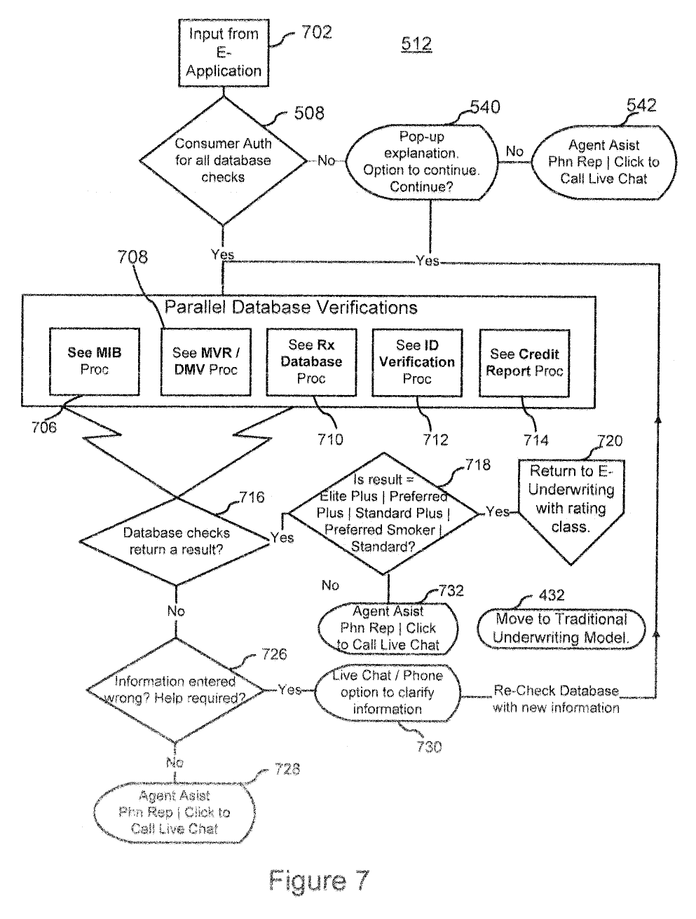

Process flow operations 512-522 are broken out into separate flow diagrams, and are explained more fully in FIGS. 7, 15, 18, 16, 17, and 13 respectively. Operations 512-522 in FIG. 5 may occur in any order, and some may occur simultaneously. As noted in FIG. 5, database process 512 encompasses a plurality of database access operations, including some or all of: MIB (Medical Information Bureau); MVR (Motor Vehicle Records); Rx (Prescription Drug Records); Credit Reports; Identity Verification (e.g., by credit report databases); proprietary databases and files (such as databases owned and operated by an insurance company); OFAC (Office of Foreign Asset Control); and Agent Contract Licensing (544).

After operations 512-522 are complete, the proposed face amount of the policy is determined (524). In some instances the applicant selects the face amount, and in other instances the face amount may be predetermined by an offer. In some embodiments, offers are made to certain groups of consumers to automatically prequalify them for certain amounts (typically small amounts). In these instances, the applicant does not require a complete underwriting process.

Information from process checks 512-522 are used to assign (526) a risk level or “class” to the applicant, and the risk level determines the premium. The lower the rating class, the higher the premium. In some embodiments, the process checks are independent, and the lowest class determined by any of the process checks is the one offered to the applicant. In some embodiments, risk levels among the process checks may be combined to calculate an aggregate risk level, which may result in a lower class than that proposed by any of the individual process checks.

In some embodiments, an applicant has the opportunity to add riders or additional benefits options, such as an accelerated death benefit, or a waiver of premium benefit (528). If the applicant adds any riders or benefit options, the premium is adjusted (530). In some embodiments, the premiums displayed are monthly amounts. The final presentation of policy specifications may allow the applicant to make changes, such as face value of the policy and benefit options (532). Once the terms of the policy are finalized, the applicant must confirm the policy terms (534). If the applicant confirms the policy terms, the method illustrated in FIG. 5 proceeds to payment of the premium and verification of the applicant's identity (536). In some embodiments, the verification of identity is performed using data from credit reporting databases. In some embodiments, the premium can be paid by periodically recurring credit card payments or periodically recurring electronic funds transfers. In some embodiment, all or part of the premium can be paid using one or more “gift cards.” For example, when a couple has a newborn, the couple's parents (i.e., the newborn's grandparents) may wish to give a gift of life insurance in which the couple is the insured and the newborn is the beneficiary. The grandparents can purchase a “gift card” that can be used for premium payments should the life insurance application be approved. It will be understood that a “gift card” need not be a physical card and can simply involve an account number of an account holding the gift amount. In some embodiments, when there is an adverse underwriting decision (AUD), an AUD letter is sent to the applicant if the applicant does not confirm the policy and the policy premium is not the best possible class (546). In some embodiments, an AUD letter may be sent as an electronic message (such as email), or may appear on a computer screen in a format suitable for printing. In some embodiments, if the applicant reaches this final stage, but chooses not to purchase the insurance coverage, the applicant's data is saved. In some embodiments, application data is saved at a plurality of stages in the application process, regardless of the applicant's choice to purchase the proposed insurance. For example, data retrieved from external databases may be saved.

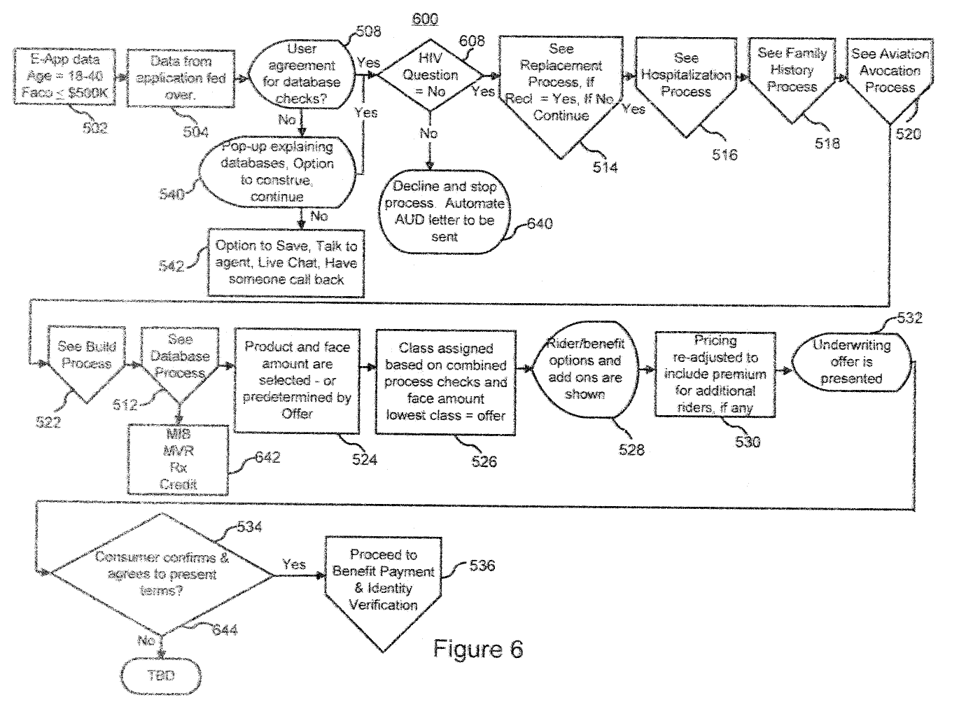

FIG. 6 illustrates an alternative embodiment that substantially corresponds to FIG. 5. The elements with the same numbers in FIGS. 5 and 6 represent the same process, so only the operations that are different in FIG. 6 will be described here. The overall process flow 600 is controlled by e-Underwriting Control Module 330, which is stored in memory 306 on Underwriting Server 104.

In the exemplary process 600 of FIG. 6, the preliminary questions are asked after the applicant has consented to the database checks, and include only the question of whether the applicant has HIV (608). If the applicant does have HIV, the process transitions to a traditional underwriting process by having the user and/or applicant speak to a customer service representative. In other embodiments, the process immediately declines coverage and sends a letter to the applicant regarding the adverse decision (an AUD letter) (640).

As in FIG. 5, FIG. 6 has a confirmation operation where the applicant must either confirm acceptance of the terms, or choose to not take the policy (534). In some embodiments, when the applicant decides to not take the policy, the data already entered by the user is saved in a database so that the applicant could return later without starting the process from the beginning (644).

FIG. 7 illustrates exemplary database access used in the online underwriting process. The database access operations 706-714 are executed by Remote Database Query Module 332 stored in memory 306 on Underwriting Server 104. The input to this portion of the process includes date of birth, driver's license number and state of issuance, current residence address including zip code, first and last name, social security number, and gender (702). As shown above with respect to FIG. 5, the process must receive authorization to perform the database checks (508). If the applicant does not give authorization, the online application process explains the need for authorization and requests authorization again (540). If authorization is still withheld, the online application process may initiate contact with a customer service representative (542). The user and/or applicant may speak to a representative immediately, wait for a call back from a representative, or begin a live online chat with a representative.

FIG. 7 illustrates five distinct database checks that may be performed. Note also that the database checks may run concurrently in parallel. The MIB process 706 indicates the likelihood that the applicant has provided falsified or misrepresented information. In some embodiments, the MIB database also provides coded medical and non-medical information provided by member life insurance companies that have previously underwritten policies for the applicant, or received a previous application for insurance from the applicant. In some embodiments, the MIB database or other similar database may provide information regarding in-force coverage, past declines, or rated cases. In some embodiments, any information retrieved from the MIB database or a similar database must be verified from another source. The MIB process 706 is performed by Fraud Detection Module 326 in memory 306 on Underwriting Server 104. This process is described more fully below with respect to FIG. 8. The MVR/DMV process 708 retrieves the applicant's driving records to estimate the likelihood the applicant will be involved in future motor vehicle accidents. This process is described more fully below with respect to FIGS. 10-12. The Rx database process 710 retrieves historical records about prescription drugs the applicant has filled. Based on the classification of the drugs filled by the applicant, the online application process determines a mortality risk, as explained more fully below with respect to FIG. 9. The Identity Verification process 712 (shown in FIG. 7 as verification process) uses specific information about the person listed as the applicant to determine if the person filling out the insurance application is the applicant identified on the electronic forms. For example, the process may ask the user to identify a street that is close to where the applicant lives, or the name of a person that the applicant should know. The fifth database process illustrated in FIG. 7 is the Credit Report process 714. The credit report process retrieves one or more credit reports and/or non-credit reports for the applicant, and assesses all elements based on a scoring system to determine risk code. The Credit Report process is described more fully below with respect to FIG. 14. Processes 708, 710, and 714 are part of the Mortality Calculation Module 328, which is stored in memory 306 on Underwriting Server 104.

If all of the database processes return results (716), the online application process can proceed to determining whether to issue a policy and what the premium should be. The lower the rating class, the higher the premium. In some embodiments, the applicable class for the applicant is the lowest class based on the various database checks. If the lowest class is at least the “standard” class (718), then the online application process continues (720). However, if the lowest class is less than the “standard class,” the online application process initiates 732 communications between the user and/or applicant and a customer service representative, which may be a voice conversation or an online live chat. The applicant would then proceed (432) with the traditional underwriting process. In alternative embodiments, the applicable class for the applicant is computed as an average or weighted average of the classes determined by individual database checks. In some embodiments, the premium rate is determined based on the risk class of the applicant, the age of the applicant, and the proposed face value of the insurance.

If one or more of the database processes 706-714 is started, but fails to return results, the online process determines whether the user entered any data incorrectly (726). In some instances a customer service representative may assist the user and/or applicant to enter the correct information (730). With the information corrected, the database checks are restarted. In some instances a customer service representative may not be able to help correct mistyped data (728), but may be able to assist the user in other ways. For example, if one or more of the third party databases is currently unavailable, the customer service representative may be able to begin a traditional underwriting process, or assist the user in saving the data so that the application process could be continued later. In some embodiments, when one or more of the databases are unavailable, the online application process collects self-reported data from the applicant, and may issue a policy contingent on subsequent verification of the self-reported data. In this scenario, the subsequent verification process could result in confirmation of the proposed policy and premium rate, confirmation of a policy at a higher premium rate, or declination to issue a policy.

One of skill in the art would recognize that an online insurance application process need not require all five database processes illustrated in FIG. 7. Based on constraints such as time, accuracy, or availability of databases, a subset of the databases identified in FIG. 8 may provide a satisfactory result.

FIG. 8 illustrates an exemplary process 706 to detect potential fraud in the insurance application. As noted above, the fraud detection process 706 is performed by the Fraud Detection Module 326 stored in memory 306 on Underwriting Server 104. This process uses the applicant's date of birth, current residence address with zip code, first name, last name, gender, and MIB hit details (802). In some embodiments, a “hit” identifies a potential match with a record in the MIB database. For example, a record with the same last name, date of birth, and a very similar residence address may be returned as a hit. In some embodiments, the MIB database returns coded medical and non-medical information that Was developed from one or more previous insurance applications by the applicant. In some embodiments, the MIB database or a similar database may provide records for policies that are currently in force, prior insurance applications that were declined, and prior rated cases (policies issued with substandard premium rates). In some embodiments, any information retrieved from the MIB database or a similar database must be verified from another source. The authorization to access the MIB database (804) was provided (508) by the applicant as part of the authorization to access databases. In some cases the MIB database may not be available, so the MIB process 706 determines (806) whether the MIB database is available. If the MIB database is not available, the online process continues (812) with the other database checks. In some embodiments, the online application process may offer the applicant temporary insurance pending the subsequent check of the MIB database. In other embodiments there is a transition 432 to the traditional underwriting process. In other embodiments, there may be an offer of temporary insurance followed by a transition to the traditional underwriting process. In some embodiments, there may be no offer of temporary insurance.

In the MIB process 706, the database query may or may not return a hit (808). If there is no hit, then the applicant “passes” the MIB test, and the other database checks continue (810). The other database checks may be running in parallel with the MIB check. In some embodiments, when there is a hit, the applicant may transition to the traditional underwriting process (814). In some embodiments, a hit prompts communication between the user and/or applicant and a customer service representative, such as by telephone or live chat. In this scenario, the customer service representative may determine that the “hit” is not associated with the applicant and returns the user to the online application process. Alternatively, a customer service representative may direct the applicant to a traditional underwriting process. In some embodiments, MIB “hits” are assigned to levels that identify the severity of the problem. In some embodiments, that assign severity levels to MIB hits, less severe problems may be addressed by live communication with a customer service representative, and allow the user to complete the application process online.

FIG. 9 illustrates an exemplary prescription drug process 710 that assesses mortality risk based on the prescription drugs that the applicant has filled. The prescription drug process 710 is performed by Mortality Calculation Module 328 in memory 306 on Underwriting Server 104. The prescription drug process uses the applicant's full name, date of birth, social security number, gender, and current zip code to access a prescription drug database (902). The applicant authorizes (904) access to the prescription drug database as part of the authorization 508 to access the relevant databases. The prescription drug process determines (906) whether the prescription drug database is available. In some embodiments, when the prescription drug database is not available, the database process 512 continues (912) with the other database access, completing and saving as much of the application process as possible. The user may resume the application process later. In other embodiments, the process transitions (432) to the traditional underwriting process when the prescription drug database is not available.

The prescription drug query in FIG. 9 may return zero or more prescription records. When there are zero records, the applicant may either have no prescription plan (“no hit”), or may have a plan that has not yet been used (“eligibility only”). When there are one or more prescription records, each of the prescriptions may be assigned a classification or level. In some embodiments, the levels are assigned the colors green, yellow, or red. In embodiments that use color designations for the class levels, green indicates a prescription that has no known mortality risk, yellow indicates a potential problem, and red indicates that manual review by an underwriter is necessary. If there are zero hits or all hits are green (908), the prescription drug check is okay (910), so the online application process continues with the other database checks.

If the prescription drug check returns some yellow results, but no red results (914), the application process initiates a live conversation with a customer service representative (916). The live conversation may be by voice or online chat. In some instances the customer service representative may be able to resolve (918) the issue, and the process continues as if there had been no yellow results (910). If the issue is not resolved, the application process transitions to the traditional underwriting process (922). In some embodiments, there is no automatic declining of insurance applications when there are yellow results. In some embodiments, when there is a question about the results, the online application process will initiate real-time communication between the user and/or applicant and a customer service representative using a phone or live chat. In some embodiments, when there are one or more red records returned by the prescription drug query (920), the application process automatically transitions to the traditional underwriting process (922).

FIGS. 10-12 illustrate an exemplary embodiment of a DMV process 708. The full process 708 comprises the flow illustrated in FIGS. 10, 11, and 12. The DMV process 708 is performed by Mortality Calculation Module 328 in memory 306 on Underwriting Server 104. In some embodiments, the process 708 utilizes tables of data, which specify points for specific violations. In some embodiments, the tables include the length of time since the last violation, the number of occurrences of the same violation, the frequency of violations, or the duration of certain violations. In some embodiments, points depend on the age of the applicant at the time of the violation.

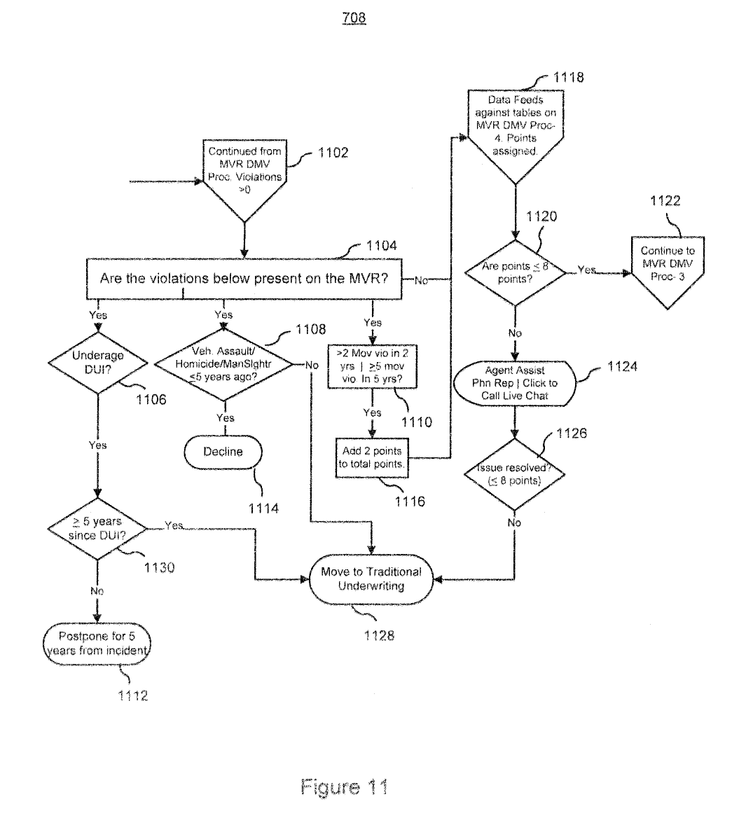

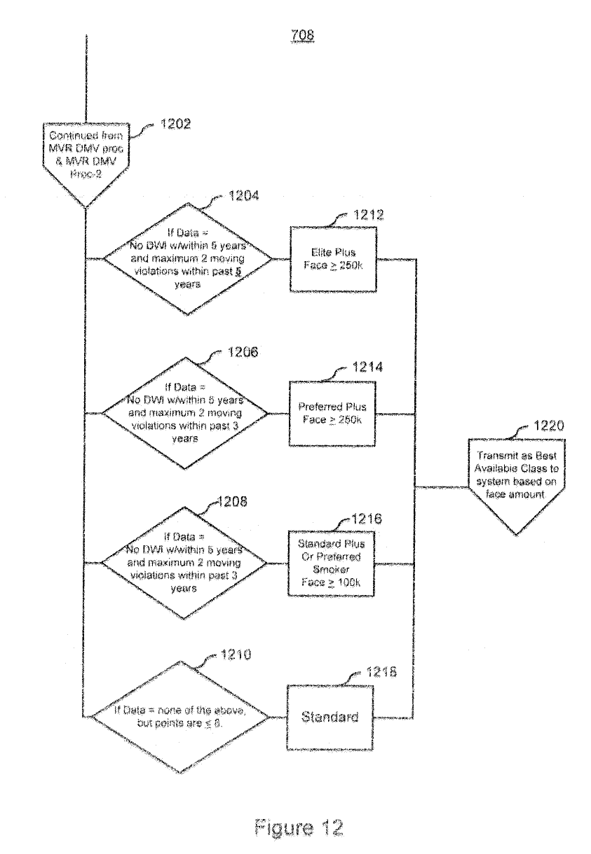

DMV process 708 uses data entered by the user (1002). In some embodiments, the data includes name, driver's license number, and state of issuance. In some embodiments, the data also includes the applicant's date of birth or social security number. The applicant authorizes (1004) access to motor vehicle records (MVR) as part of the authorization 508 to access the relevant databases. The DMV process determines if the MVR database is available (1006). Although referred to herein as a single database, motor vehicle records may be contained in many different databases. For example, a person who has lived in several different states may have records in databases for more than one state, and those records may be in physically distinct databases. If the MVR database is available, DMV process 708 queries the MVR database for violations by the applicant (1008). If the applicant has no violations, process 708 continues 1010 to the rating assignment phase shown in FIG. 12, beginning at box 1202. If the applicant has one or more violations, the process continues 1020 to the DMV detailed analysis phase shown in FIG. 11, beginning at box 1102.

If the MVR database is not available, the resident state of the applicant determines 1012 the next step. In some embodiments, if the resident state of the applicant is Alaska, Hawaii, Washington, or Wyoming, then the underwriting process will continue to issue temporary insurance pending future retrieval of MVR results (1018). In other embodiments or in other states, when the MVR database is unavailable, the DMV process 708 prompts the user to enter driving data (1014). State laws regarding the use of motor vehicle records are subject to change, so embodiments would generally apply the appropriate rules based on current state law, and the relevant set of states could change over time as state laws change. In some embodiments, temporary insurance is not provided under any circumstances, or in limited circumstances only. An exemplary question posed to the applicant is “In the past two years, have you had your driver's license revoked, suspended, or been convicted of reckless driving, driving without a valid license or for driving while under the influence of alcohol or drugs (DWI, DUI)? Or have you had more than two moving violations in the past 12 months? If the answers to any of the questions are yes, then the application process transitions to the traditional underwriting process (1016). If the answer to all of the questions is no, then the application process continues 1018 towards issuance of a temporary policy subject to review of subsequent MVR results. In this scenario, the online underwriting process proceeds as if the best rating class is available until the motor vehicle records are available (1022). When online underwriting continues 1018 without access to DMV records, the process moves 1010 to the rating assignment phase depicted in FIG. 12, beginning at box 1202. In some embodiments, there is no issuance of a temporary policy.

FIG. 11 illustrates an exemplary process flow of the detailed analysis of violations recorded in the MVR database. The process begins at box 1102, which continues from box 1020 in FIG. 10. The analysis categorizes the violations into four groups (1104): Underage DUI; vehicular assault/homicide/manslaughter; other moving violations; all other violations. If the violations include an underage DUI (1106), the consequence depends on the length of time since the violation. If the violation was less than 5 years ago (1130), then the application process is postponed (1112). In some embodiments, when the underage DUI was at least 5 years ago, then the violation is treated as a moving violation, which is addressed below. In other embodiments, when the underage DUI was at least five years ago, the application process transitions to traditional underwriting (1128).

If there are any vehicular assault/homicide/manslaughter convictions (1108), the process flow depends on how long ago the violation occurred. If the violation was less than five years ago, then the online application process immediately terminates, declining to offer coverage to the applicant (1114). If the violation was more than five years ago, the application process may continue, but transitions to the traditional underwriting process (1128).

If the applicant has no vehicular assault/homicide/manslaughter convictions or underage DUI violations in the past 5 years, process 708 calculates a numeric point total that measures the applicant's risk. Because vehicle accidents are a leading cause of death in the target age group 18-40, the driving record correlates to mortality risk. In some embodiments, additional points are added to the point total if the applicant has had a large number of violations in a short period of time (1110). In one exemplary embodiment, two points are added (1116) to the total if the applicant has had two or more violations in the past two years or five or more violations in the past five years. In some embodiments, the points assigned to each violation are determined by lookup in a table (1118). In some embodiments, the number of points is assigned for specific violations based on the date of the most recent violation, the frequency of violation, or the duration of the violation. In some embodiments, SwissRe (or other underwriting reinsurer) assigns a number of points for the violations. In other embodiments, the online application process assigns the points for violations. In some embodiments, the lookup uses both the classification of the violation as well as the time elapsed since the violation. The points for each violation are added together to compute a total point value. If the total points is at most eight (1120), the DMV process continues 1122 to the rating assignment phase shown in FIG. 12, which begins at 1202. In some embodiments, if the total points exceed 8, the application process transitions to the traditional underwriting process (1128). In other embodiments, when the total points exceed 8, the DMV process 708 initiates a phone conversation or online live chat between the user and/or applicant and a customer service representative (1124). In some embodiments, the customer service representative has the authority to modify the point total (1126), which may result in continuation of the online underwriting process (1122). One of skill in the art would recognize that many alternative point assignment methodologies are possible for assessing mortality risk based on an applicant's driving record. In particular, the methodology may adapt as new statistics regarding driving records becomes available.

FIG. 12 illustrates an exemplary rating assignment phase based on MVR records, continuing the DMV process from FIG. 10 or FIG. 11 (1202). The rating assignment is based on specific types of violations, or quantity of violations over periods of time. In this embodiment, the rating assignment is based on recent DWI (or DUI) violations, as well as the total number of recent moving violations. One of skill in the art of insurance underwriting would recognize that other time frames or other violations could be used in the rating assignment, and that many alternative rating classifications could be used. In the embodiment shown in FIG. 12, the DMV data together with the requested face value of the insurance determine the rating class of the applicant. In other embodiments the rating class is determined based solely on the DMV data. In the embodiment shown in FIG. 12, the highest rating is labeled “Elite Plus,” and is assigned (1212) to an applicant who has no DWI violations in the past five years and a maximum of two moving violations in the past five years (1204). The Elite Plus class is only assigned to applicants seeking a face value of $250,000 or more (otherwise a lower rating applies). The next highest rating “Preferred Plus” is assigned (1214) to an applicant who has no DWI violations in the past five years and a maximum of two moving violations in the past three years (1206). In addition, the Preferred Plus rating applies only when the applicant is a non-smoker and seeks an insurance face value of $250,000 or more. The “Standard Plus” or “Preferred Smoker” rating is assigned (1216) to applicants who have no DWI violations in the past five years and a maximum of two moving violations in the past three years. This has the same driving criteria as the Preferred Plus class, but applies when the applicant is a smoker or seeks an insurance face value less than $250,000. If none of the other criteria apply (1210), the applicant is assigned the standard rating (1218). Regardless of what rating is assigned, the rating is forwarded (1220) to the remainder of the online underwriting process.

FIG. 13 illustrates an exemplary process 522 for evaluating mortality based on the applicant's build (e.g., height and weight). In some embodiments, the age of the applicant is also used as part of the build process. The mortality risk based on build begins with entry of the applicant's height and weight (1302). In embodiments where the applicant's age is considered, the applicant must enter that information as well. Based on the entered build information, a rating is assigned to the applicant (1304). In some embodiments, the rating is assigned using one or more tables. In some embodiments, the rating is assigned using a formula or calculation. As long as the assigned rating is at least a minimum rating (1306), the online application process continues (1308). In some embodiments, the minimum rating is labeled “standard.” In some embodiments, ratings that are better than standard are identified as “Elite,” “Elite Plus,” “Preferred,” or “Preferred Plus.” In other embodiments, ratings that are better than standard are identified as “Elite Plus,” “Preferred Plus,” “Standard Plus,” and “Preferred Smoker,” which are in addition to “Standard” and “Standard Smoker” rate classes. The specific nomenclature is exemplary and can be useful to identify the levels of mortality risk.

When the applicant's build rating is below the minimum, the build process 522 initiates phone conversation or online live chat between the user and/or applicant and a customer service representative (1310). In some embodiments, the customer service representative may adjust the assigned rating when the applicant's weight is “close” to the weight that would be assigned the minimum rating. In some embodiments, the “wiggle room” is five pounds. Based on the communication with the customer service representative, the application process may transition to the traditional underwriting process (1312). In some instances the customer service representative may be able to assign the minimum rating and continue (1308) with the online application process.

FIG. 14 illustrates an exemplary process 714 for evaluating mortality based on information contained in a credit report. The credit report process 714 is performed by Mortality Calculation Module 328 in memory 306 on Underwriting Server 104. Process 714 uses data input in the online application process (1402). This information may include name, Social Security Number, current or former addresses, date of birth, or other data to identify the financial data of the insurance applicant. This information is transmitted to one or more credit companies (1404), and non FCRA (Fair Credit Reporting Act) credit data is returned (1406). In some instances federal or state law may limit what financial or credit data may be used. Using the credit data, process 714 calculates a risk code for the applicant (1408). The risk code may be computed based on one or more pieces of information in the credit data, but the result is a single aggregate risk code. In some embodiments, the risk code is a positive integer, and may range from 1 to 100. In other embodiments the risk code may have a smaller or larger range of possible values. In some embodiments, the risk code is alphanumeric or a decimal number. In the embodiment shown in FIG. 14, a higher risk code number indicates a lower risk individual. In alternative embodiments, a higher number represents higher risk. Exemplary factors that may be included in the risk code calculation are: number, frequency, and recency of delinquent payments; the length of time that payments have been delinquent (e.g., 30 days, 60 days, 90 days); the size of the individual's debt compared to income; whether the individual has filed for bankruptcy (and if so, how recently); the number of credit cards issued to the applicant and the combined credit limit; and ownership of a home. Other factors may be included when research establishes a correlation between the financial information and mortality. The assignment of risk code is similar to the Predictive Financial Model (PFM) used for auto and home insurance, but used to predict mortality rather than financial risk. Note that the process does not use a FICO or other credit score computed by a credit reporting agency.

Based on the risk code, the application process assigns a rating class (1410). In the embodiment shown in FIG. 14, better rating classes are assigned to higher risk code numbers. In the embodiment of FIG. 14, a risk code of at least 90 (1412) results in assigning the Elite Plus rating class (1422). When the risk code is between 80 and 89 (1414), the applicant is assigned to the Preferred Plus rating class (1424). When the risk code is between 76 and 79 (1416), the applicant is assigned the Standard Plus rating class (1426). In some embodiments, an applicant who is a smoker is assigned to the Preferred Smoker rating class when the risk code is any number greater than 75 (so a smoker would not be in the Elite Plus or Preferred Plus rating class even with a high value for the code). In the embodiment shown in FIG. 14, the Standard rate class applies (1428) when the risk code is between 70 and 75 (1418). Whenever the risk code is less than 70 (1420), the process transitions to traditional underwriting (1430). As long as a standard or better rating class has been assigned, the rating class is coordinated with the other independent database checks to compute an aggregate rating class (1432).

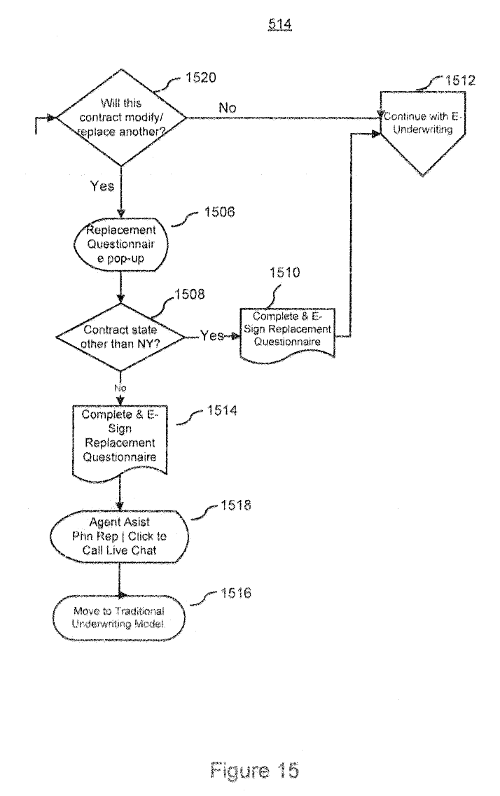

FIG. 15 illustrates an exemplary process 514 that applies when the proposed insurance will replace an existing insurance policy. The process first determines whether proposed coverage under the current insurance application is intended to replace existing coverage (1520). If not, the online application process continues, as shown in FIGS. 5 and 6. Note also that process 514 is the same regardless of whether the proposed insurance will replace an individual policy or a group policy. When the proposed insurance is a replacement, the application process provides an additional questionnaire for the applicant (1506), which includes determining the state under which the proposed insurance contract will be issued (1508). If the state is New York, the applicant electronically signs the questionnaire (1514), and the application process initiates (1518) a phone call or live chat with the user and/or applicant before transitioning to the traditional underwriting process (1516). However, for any other state, the applicant electronically signs the questionnaire (1510), and the online application process continues (1512). In some embodiments, the state of the contract to be replaced is asked earlier, such as at operation 402 in FIG. 4.

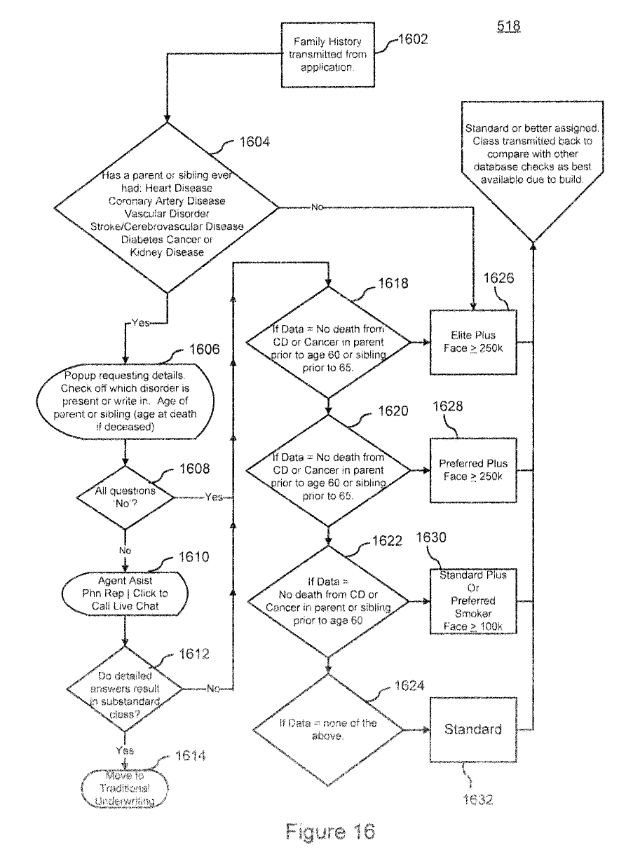

FIG. 16 illustrates an exemplary process 518 for determining mortality risk based on the family history of the applicant. Initially, the process uses family history data entered by the user (1602). In some embodiments, the family history data includes medical history data about parents, siblings, or both parents and siblings of the applicant. As shown, an exemplary set of questions asks about heart disease, coronary artery disease, vascular disorder, stroke or other cerebrovascular disease, diabetes, cancer, and kidney disease (1604). In alternative embodiments, larger or smaller sets of medical conditions are considered. If the applicant has no parents or siblings that have or had any of the listed medical conditions, the online application process proceeds to establish the proper rating class, beginning at Elite Plus. As with DMV data, the medical data may be combined with the requested face value to determine the appropriate rating class. In some embodiments, the rating class is assigned without regard to the face value requested. If the applicant has requested a face value of at least $250,000, then the Elite Plus rating class is assigned (1626). If the requested face value is less than $250,000, but at least $100,000, the applicant is assigned to the Standard Plus or Preferred Smoker rating class depending on whether the applicant smokes (1630). Finally, if the applicant seeks a face value of less than $100,000, the applicant is assigned to the Standard rating class (1632).

If the applicant does have a parent or sibling with one of the identified medical conditions, further details are requested, including the specific medical conditions at issue (1606). In some embodiments, the application process requests information about the parent's or sibling's age, or the age at death if the person is deceased. If the detailed answers show no serious problem (1608), the process continues with the assignment of an appropriate rating class. In many cases it will be necessary for the user and/or applicant to communicate with a customer service representative (or other agent) to clarify the details (1610). In some embodiments, the communication is by phone or live chat. Based on the detailed information provided, the online application process determines whether the medical conditions result in a substandard rating class (1612). If the rating class is substandard, the process transitions to traditional underwriting (1614).

As long as the rating class is not substandard, the process continues to assign the proper rating class based on a combination of the medical information and the desired face value of the policy. In alternative embodiments the rating class is assigned without regard to the face value desired. In the embodiment shown in FIG. 16, the Elite Plus rating class is assigned (1626) when the desired face value is at least $250,000, there has been no death of a parent from coronary disease or cancer prior to age 60, and no death of a sibling due to coronary disease or cancer prior to age 65 (1618). In this embodiment, if not all three of these criteria are met, a lower rating class will be assigned. In some embodiments, the same test of medical conditions and face value occurs again (1620), which may result in the Preferred Plus rating class (1628). In some embodiments, the medical conditions test or desired face value are different for the Preferred Plus rating class.

In the embodiment shown in FIG. 16, the next rating class applies when the desired face value is at least $100,000 and there has been no death of a parent or sibling due to coronary disease or cancer prior to age 60 (1622). In this case, the applicant is assigned a rating class of Standard Plus if a non-smoker, or Preferred Smoker otherwise (1630). If none of the above rating classes apply (1624), the applicant is assigned to the Standard rating class (1632).

One of skill in the art of insurance underwriting would recognize that many different rating classifications could be used here, and that many alternative formulations of medical conditions could be used to assign rating classes. Alternative embodiments could also use different age ranges for the conditions to assign the rating classes.

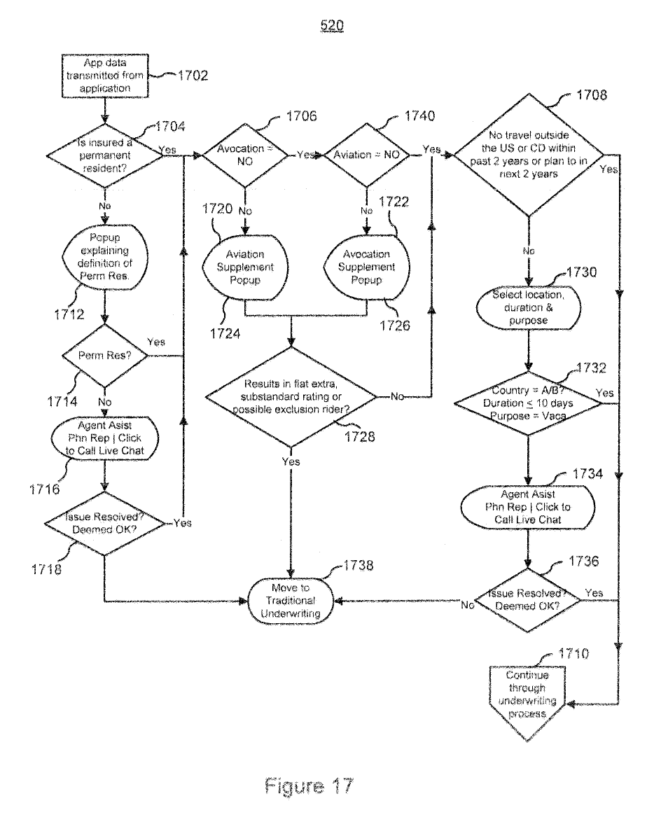

FIG. 17 illustrates an exemplary process 520 for determining mortality risk based on the applicant's avocation and aviation history and/or plans. As used herein, avocation includes an individual's profession, hobbies, sports, and other physical activities. Process 520 begins by collecting the relevant data from the applicant (1702). In some embodiments, a determination is made whether the applicant is a citizen or permanent resident of the United States (1704). If the user responds no, process 520 provides an explanation (1712). In some embodiments, the explanation may appear as a popup. After providing the explanation, process 520 asks again whether the applicant is a citizen or permanent resident (1714). If the applicant still believes that the answer is no, the process 520 initiates a phone conversation or online live chat between the user and/or applicant and a customer service representative (1716). If the customer service representative determines (1718) that the applicant is not a citizen or permanent of the United States, the application process transitions to the traditional underwriting process (1738).

If the applicant is a citizen or permanent resident of the United States, process 520 proceeds to evaluate the applicant's profession, physical activities such as sports, and hobbies that entail risk (1706). The online application process also evaluates the applicant's aviation history and/or plans (1740). In some embodiments, questions regarding profession, physical activities, and aviation are asked together. An exemplary question is “in the past or next 12 months, have you engaged in or do you plan to engage in risky activities, extreme sports or have you flown a plane other than as a commercial airline pilot? Or are you engaged in a hazardous occupation that exposes you to the risk of loss of life?” An alternative exemplary question that addresses solely aviation is “within the past three years has the Proposed Insured flown in a plane other than as a passenger on a commercial airline or does he or she have plans for such activity within the next year?” An alternative exemplary question that addresses risky activities is “Within the past three years has the Proposed Insured participated in or does he or she plan to participate in any of the following? (1) Underwater sports—SCUBA diving, skin diving, or similar activities; (2) Racing sports—motorcycle, auto, motor boat or similar activities; (3) Sky sports—skydiving, hang gliding, parachuting, ballooning or similar activities; (4) Rock or mountain climbing or similar activities; or (5) Bungee jumping or similar activities.” If there are any aviation events planned (1720), the online application process proceeds to collect supplemental data about those plans (1724). Similarly, if the applicant is involved in any risky activities (such as at work or in recreation), the online application process collects supplemental information about those activities (1726).

The additional information regarding the applicant's profession, physical activities, and aviation history and/or plans is evaluated to determine how it will affect potential coverage or premium rate (1728). In some instances, the additional information may result in an extra flat premium amount. In other instances, the additional information may result in a sub-standard premium rate. In other instances, there may be an exclusion rider that excludes from coverage the identified high risk activities. If the additional information results in any additional premium, sub-standard rating, or exclusion rider, the application process transitions to the traditional underwriting process (1738).

If the additional information about avocation or aviation does not have any adverse impact on premium amount or coverage, process 520 continues to evaluate travel outside of the United States (1708). Evaluation 1708 also occurs when the applicant has no avocation or aviation issues to address. Some states impose restrictions on what questions about travel may be asked of applicants, and those state rules are subject to change. Subject to state-imposed restrictions, an exemplary process is described. The window of time evaluated is the prior two years and plans for the upcoming two years. If the applicant has not and will not travel outside of the United States (or Canada) in that 4 year window, the online underwriting process continues (1710).

For each destination outside of the United States or Canada that the applicant has or will travel within the four year window, the applicant may identify the location, the duration of the visit, and the purpose (1730). In some embodiments, only a subset of these three items is sought for each destination. In some embodiments, countries are grouped into four categories A, B, C, and D, which correlate to mortality risk for travel to each of the countries. In other embodiments each country is assigned an individual mortality risk. Process 520 selects a threshold level of mortality risk, and compares the mortality risk of each applicant travel destination to the threshold. In some embodiments, the threshold for future travel is different from the threshold used for travel that has already occurred. Process 520 evaluates the mortality risk for each destination (1732). In some embodiments, the evaluation includes an evaluation of the destination country, the duration of the stay in that country, and the purpose. In some embodiments, a destination is not considered to have a significant mortality risk if the destination country has a risk threshold below a threshold value, the duration of the stay is at most 10 days, and the purpose of the trip is for a vacation. In some embodiments that categorize destinations into A, B, C, and D risk levels, the threshold is “B,” thus allowing any country categorized as A or B. If each of the destinations passes each of the applied tests, the online underwriting process continues (1710). In some embodiments, failure of any test for any of the destinations requires transition to the traditional underwriting process. In some embodiments, failure of any test for any of the destinations initiates a phone conversation or online live chat between the user and/or applicant and a customer service representative (1734). If the customer service representative is able to resolve 1736 the issue(s), the online underwriting process continues; otherwise, the application process transitions to the traditional underwriting process (1738).

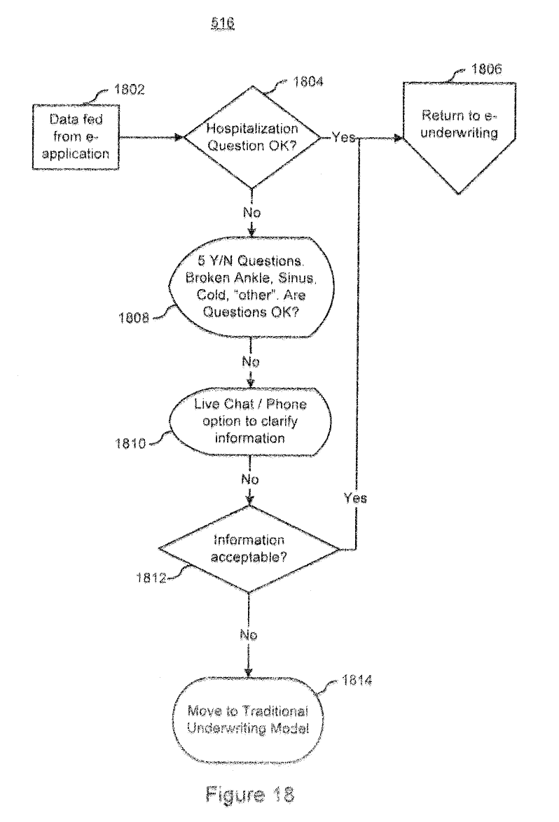

FIG. 18 illustrates an exemplary process for assessing mortality risk based on prior hospitalization or medical treatment of the applicant. The hospitalization or medical treatment data entered by the user is fed into the hospitalization analysis (1802). The process reviews (1804) whether the applicant has been hospitalized, and if not, continues 1806 with the online underwriting process. An exemplary hospitalization or medical treatment question is “in the past 10 years, have you been advised to have treatment for, or have you been treated for or consulted a physician or other practitioner for any of the following: heart or coronary artery disease or disorder, stroke, peripheral vascular disease, cancer, diabetes, hepatitis C, cirrhosis, pancreas disease or disorder, emphysema or chronic lung or pulmonary disease (COLD or COPD), alcohol or drug use?” An alternative or supplemental exemplary hospitalization or medical treatment question is “in the past 5 years, have you been hospitalized for the following: chest pain, high blood pressure, asthma, depression, manic-depression, other mental or nervous system disorder, connective tissue disease, paralysis, seizure, anemia, or kidney or liver disease or disorder (excluding kidney stones)?” Another alternative or supplemental exemplary hospitalization question is “are you currently hospitalized, or in the past 12 months have you either been hospitalized for 5 or more consecutive days, or were you unable to work for more than 5 consecutive days other than for childbirth? Or have you been advised to have, or are you awaiting results of non routine medical tests or procedures?”

If there is an affirmative response to any of the hospitalization questions, the online application process seeks answers to follow up questions regarding the nature of the hospitalization (1808). In some embodiments, if the hospitalization was solely for a broken ankle, sinus infection, cold, or other designated ailments, the online application process may be able to proceed. In some embodiments, the online application process will initiate a phone conversion or online live chat between the user and/or applicant and a customer service representative (1810). Based on the information provided by the applicant, the customer service representative determines 1812 whether the responses are acceptable. If so, the online application process continues (1806). If the responses are not acceptable, the process transitions 1814 to the traditional underwriting process. In some embodiments, there are objective criteria to determine whether the responses are acceptable.

The foregoing description, for purpose of explanation, has been provided with reference to specific embodiments. However, the illustrative discussions above are not intended to be exhaustive or to limit the invention to the precise forms disclosed. Many modifications and variations are possible in view of the above teachings. For example, in some embodiments, some of the operations of the application process could be performed on paper, in person, or on a phone. In another embodiment, an online process as described above could be used to generate a paper application that is subsequently submitted to an insurance underwriter. In addition, the operations of the online underwriting process described above relate to particular embodiments. The embodiments were chosen and described in order to best explain the principles of the invention and its practical implementations, to thereby enable others skilled in the art to best utilize the invention and various embodiments with various modifications as are suited to the particular use contemplated. For example, other embodiments can employ different arrangements and combinations of the described operations, including subsets or supersets of the described operations; differently worded questions; subsets or supersets of the questions; different decision thresholds (such as age or face value thresholds); or different application process workflows.

What is claimed is:

1. A method of underwriting an insurance policy, performed at a server with one or more processors and memory, comprising:
receiving submitted personal information about a person, wherein the submitted personal information includes a plurality of characteristics pertaining to the person's health, profession, planned physical activities, or travel activities;
receiving authorization from the person to access a plurality of databases to retrieve information about the person;
retrieving stored personal information about the person from the plurality of databases;
computing a mortality risk based on the stored personal information and the submitted personal information;
declining to underwrite an insurance policy for the person when the mortality risk exceeds a threshold value; and
making an offer to underwrite an insurance policy for the person with a premium based on the mortality risk when the mortality risk is less than or equal to the threshold.

2. The method of claim 1 wherein the stored personal information includes prescription drug information.

3. The method of claim 1 wherein the stored personal information includes driving records from a motor vehicle records database.

4. The method of claim 1 wherein the stored personal information includes one or more credit reports.

5. The method of claim 1 wherein the stored personal information includes at least one of: height, weight, age, and an indication of whether the person uses tobacco.

6. The method of claim 1 further comprising computing said mortality risk based on said information retrieved from said plurality of databases.

7. The method of claim 6, wherein said plurality of databases includes at least one of: a drug prescription database, a motor vehicle records database, and a credit information database.

8. A method of underwriting an insurance policy, performed at a server with one or more processors and memory, comprising:
receiving submitted personal information from a person, wherein the submitted personal information includes a plurality of characteristics pertaining to the person's health, profession, planned physical activities; or travel activities;
receiving authorization from the person to access a database to retrieve information about the person;
retrieving stored personal information about the person from previous applications for insurance, wherein the stored personal information includes a plurality of characteristics pertaining to the person's health, profession, planned physical activities, or travel activities;
computing a risk of fraud based on comparing the submitted personal information to the stored personal information; and
declining to underwrite an insurance policy for the person when the risk of fraud exceeds a threshold value.

9. The method of claim 8 wherein the stored personal information is retrieved from the Medical Information Bureau.

10. A method of estimating mortality risk, performed on a computer system with one or more processors and memory, comprising:
identifying a person for whom a mortality risk assessment is desired;
receiving authorization from the person to retrieve financial data;
retrieving one or more credit reports for the person from credit reporting agencies; and
computing a mortality risk score from the one or more credit reports, wherein the computing includes associating at least one item of information from the one or more credit reports with increased or decreased mortality risk, and the at least one item of information includes information other than a credit score calculated by the credit reporting agencies.
